(19) United States
(12) Patent Application Publication
(10) Pub. No.: US 2024/0221711 A1
(43) Pub. Date: Jul. 4, 2024

(54) SYSTEMS, METHODS, AND APPARATUSES FOR CONTROL OF APPLIANCE SOUND AND/OR PRESSURE

(71) Applicant: Vita-Mix Management Corporation, Olmsted Township, OH (US)

(72) Inventors: Thomas Clynne, Olmsted Township, OH (US); David Kolar, Olmsted Township, OH (US); Kyle Jones, Olmsted Township, OH (US); Carson McCandless, Olmsted Township, OH (US); Charles Joseph Tromm, Olmsted Township, OH (US)

(21) Appl. No.: 18/399,490

(22) Filed: Dec. 28, 2023

Related U.S. Application Data
(60) Provisional application No. 63/435,897, filed on Dec. 29, 2022.

(51) Int. Cl. G10K 11/00; B01F 35/212; B01F 35/22; B01F 35/221; B01F 35/222; B01F 35/32; B01F 101/06; H02P 9/02; H02P 9/08; H04R 29/00

(52) U.S. Cl. CPC G10K 11/002; B01F 35/212; B01F 35/2202; B01F 35/22161; B01F 35/222; G10K 11/004; H02P 9/02; H02P 9/08; H04R 29/004; B01F 35/3204; B01F 2101/06

(57) ABSTRACT

Provided are systems and methods for reduced-noise blending systems. For example, a blending system may capture and analyze sound and/or vibration of the blending system and adjust one or more aspects of the blending system to reduce the sound and/or vibration based on the captured information to provide feedback control.

### CROSS-REFERENCE TO RELATED APPLICATION

The present disclosure claims the priority benefit of U.S. Provisional patent application Ser. No. 63/435,897, filed Dec. 29, 2022 and entitled “SENSING AND FEEDBACK CONTROL OF APPLIANCE SOUND AND/OR PRESSURE” the entire contents of which is incorporated by reference herein.

### TECHNICAL FIELD

The present disclosure relates to reduced-noise blending systems and, more particularly, to systems and methods for reducing sound, vibration, and/or pressure of blending systems.

### BACKGROUND

Blenders and blending systems are often used to blend and process foodstuffs.

Many kitchen appliances utilize electrical motors as part of a blending, chopping or other rotary process, and the operation of the device and the mixing of foodstuff can be noisy and loud. Given the wide variety of uses for blenders and different environments in which they may be used, such sound may be undesirable to certain individuals in certain environments. For example, consumers and appliance operators may find excessive noise to be offensive and undesirable. Limiting the operational noise generated by an appliance may be a desirable feature and can provide significant commercial advantages. Nevertheless, traditional methods of operation of typical kitchen appliances are often geared toward the production of a final result, with the amount of acoustic noise generated as a result taken as a lower priority operational feature. When noise is addressed, the resulting products are generally larger, more expensive to manufacture, mechanically complex, and/or have thermal issues that can cause certain components to overheat.

### SUMMARY

The following presents a summary of this disclosure to provide a basic understanding of some aspects. This summary is intended to neither identify key or critical elements nor define any limitations of embodiments or claims. This summary may provide a simplified overview of some aspects that may be described in greater detail in other portions of this disclosure. Furthermore, any of the described aspects may be isolated or combined with other described aspects without limitation to the same effect as if they had been described separately and in every possible combination explicitly.

In one aspect, a system for operating a sound reducing system, the system comprising: a blender comprising a motor; a capture component comprising one or more sensors configured to capture sensor information associated with the blender; and a controller communicatively coupled to the motor and the capture component, the controller configured to: obtain the sensor information captured by the one or more sensors; determine an acoustic output of the blender based on the sensor information, wherein the acoustic output comprises a sound pressure output associated with the blender; determine the acoustic output does not satisfy a threshold parameter; and adjust one or more operational parameters of the blender based on determining that the acoustic output does not satisfy the threshold parameter.

In another aspect, a blender comprising: a motor; and a controller communicatively coupled to the motor, the controller configured to: obtain the sensor information captured by one or more sensors associated with the blender; determine an acoustic output of the blender based on the sensor information, wherein the acoustic output comprises a sound pressure output associated with the blender; determine the acoustic output does not satisfy a threshold parameter; and adjust one or more operational parameters of the blender based on determining that the acoustic output does not satisfy the threshold parameter.

In yet another aspect, a method for operating a sound reducing system, the method comprising: obtaining sensor information captured by one or more sensors associated with a blending system; determining an acoustic output of the blending system based on the sensor information, wherein the acoustic output comprises a sound pressure output associated with the blending system; determining the acoustic output does not satisfy a threshold parameter; and adjusting one or more operational parameters of the blending system based on determining the acoustic output does not satisfy the threshold parameter.

The following description and the drawings disclose various illustrative aspects. Some improvements and novel aspects may be expressly identified, while others may be apparent from the description and drawings.

### DESCRIPTION OF THE DRAWINGS

The accompanying drawings illustrate various systems, apparatuses, devices and methods, in which like reference characters refer to like parts throughout, and in which:

FIG. 1 is a block diagram of an illustrative embodiment of a blender system in accordance with various disclosed aspects herein;

FIG. 2 is an environmental view of an illustrative embodiment of a blender system in accordance with various disclosed aspects herein;

FIG. 3 is a functional component diagram of an embodiment of a blender system in accordance with various disclosed aspects herein;

FIG. 4 is a flow diagram of an illustrative embodiment of a method associated with a blender system in accordance with various disclosed aspects herein;

FIG. 5 is an environmental diagram of an illustrative communication system in accordance with various disclosed aspects herein;

FIG. 6 is a block diagram of an illustrative functional computer system in accordance with various disclosed aspects herein; and

FIG. 7 is a front view of an illustrative blending system in accordance with various disclosed aspects herein.

The present disclosure may be embodied in several forms without departing from its spirit or essential characteristics. The scope of the present disclosure is defined in the appended claims, rather than in the specific description preceding them. All embodiments that fall within the meaning and range of equivalency of the claims are therefore intended to be embraced by the claims.

### DETAILED DESCRIPTION

Reference will now be made to illustrative embodiments, examples of which are illustrated in the accompanying drawings. It is to be understood that other embodiments may be utilized and structural and functional changes may be made. In addition, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

In addition, terms such as “access point,” “server,” and the like, are utilized interchangeably, and refer to a network component or appliance that serves and receives control data, voice, video, sound, or other data-stream or signaling-stream. Data and signaling streams may be packetized or frame-based flows. Furthermore, the terms “user,” “customer,” “consumer,” and the like are employed interchangeably throughout the subject specification, unless context suggests otherwise or warrants a particular distinction among the terms. It is noted that such terms may refer to human entities or automated components supported through artificial intelligence (e.g., a capacity to make inference). Still further, “user,” “customer,” “consumer,” may include a commercial establishment(s), such as a restaurant, restaurant chain, commercial kitchen, grocery store, convenience store, ice-cream shop, smoothie restaurant, or the likes.

“Logic” refers to any information and/or data that may be applied to direct the operation of a processor. Logic may be formed from instruction signals stored in a memory (e.g., a non-transitory memory). Software is one example of logic. In another aspect, logic may include hardware, alone or in combination with software. For instance, logic may include digital and/or analog hardware circuits, such as hardware circuits including logical gates (e.g., AND, OR, XOR, NAND, NOR, and other logical operations). Furthermore, logic may be programmed and/or include aspects of various devices and is not limited to a single device.

A network typically includes a plurality of elements that host logic. In packet-based wide-area networks (WAN), servers (e.g., devices including logic) may be placed at different points on the network. Servers may communicate with other devices and/or databases. In another aspect, a server may provide access to a user account. The “user account” includes attributes for a particular user and commonly include a unique identifier (ID) associated with the user. The ID may be associated with a particular mobile device and/or blending device owned by the user. The user account may also include information such as relationships with other users, application usage, location, personal settings, and other information.

Embodiments may utilize substantially any wired or wireless network. For instance, embodiments may utilize various radio access network (RAN), e.g., Wi-Fi, global system for mobile communications, universal mobile telecommunications systems, worldwide interoperability for microwave access, enhanced general packet radio service, third generation partnership project long-term evolution (3G LTE), fourth generation long-term evolution (4G LTE), third generation partnership project (2G) BLUETOOTH®, ultra mobile broadband, high speed packet access, x^{th} generation long-term evolution, or another IEEE 802.XX technology. Furthermore, embodiments may utilize wired communications.

It is noted that, terms “user equipment,” “device,” “user equipment device,” “client,” and the like are utilized interchangeably in the subject application, unless context warrants particular distinction(s) among the terms. Such terms may refer to a network component(s) or appliance(s) that sends or receives data, voice, video, sound, or substantially any data-stream or signaling-stream to or from network components and/or other devices. By way of example, a user equipment device may include an electronic device capable of wirelessly sending and receiving data. A user equipment device may have a processor, a memory, a transceiver, an input, and an output. Examples of such devices include cellular telephones (e.g., smart phones), personal digital assistants (PDAs), portable computers, tablet computers (tablets), hand-held gaming counsels, wearables (e.g., smart watches), desktop computers, etc.

It is noted that user equipment devices can communicate with each other and with other elements via a network, for instance, a wireless network, or a wireline network. A “network” can include broadband wide-area networks such as cellular networks, local-area networks, wireless local-area networks (e.g., Wi-Fi), and personal area networks, such as near-field communication networks including BLUETOOTH®. Communication across a network may include packet-based communications, radio and frequency/amplitude modulations networks, and the like.

Communication may be enabled by hardware elements called “transceivers.” Transceivers may be configured for specific networks, and a user equipment device may have any number of transceivers configured for various networks. For instance, a smart phone may include a cellular transceiver, a Wi-Fi transceiver, a BLUETOOTH® transceiver, or may be hardwired. In those embodiments in which it is hardwired, any appropriate kind or type of networking cables may be utilized. For example, USB cables, dedicated wires, coaxial cables, optical fiber cables, twisted pair cables, Ethernet, HDMI and the like.

It is noted that the various embodiments described herein may include other components and/or functionality. It is further noted that while various embodiments refer to a blender or a blender system, various other systems may be utilized in view of embodiments described herein. For example, embodiments may be utilized in food processor systems, mixing systems, hand-held blending systems, various other food preparation systems, and the like. As such, references to a blender, blender system, and the like, are understood to include food processor systems, and other mixing systems.

The systems described herein generally include a blender base that may include a motor, a control system, a display, a memory and a processor. Further, such systems may include a blending container and a blade assembly. The blade assembly, the blending container, and the blender base may removably or irremovably attach to one another. The blending container may be powered in any appropriate manner. For example, a power source may be configured to power the blending container. The power source may be positioned in the blending container and/or the blending base. The power source may be wireless. In examples, the power source may be an energy storage device, such as a rechargeable or nonrechargeable battery, a regenerative power supply, and/or the like. Foodstuff or other items may be added to the blender container. Furthermore, while blending of “ingredients,” “contents” or “foodstuffs” is described by various embodiments, it is noted that non-food stuff may be mixed or blended, such as paints, epoxies, construction material (e.g., mortar, cement, etc.), and the like. Further, the blending systems may include any household blender and/or any type of commercial blending system, including those with covers that may encapsulate or partially encapsulate the blender. Further, commercial blending systems may include an overall blending system, such as a modular blending system that may include the blender along with other components, such as a cleaner, foodstuff storage device (including a refrigerator), an ice maker and/or dispenser, a foodstuff dispenser (a liquid or powder flavoring dispenser) or any other combination of such.

As used herein, the phrases “blending process,” “blending program,” and the like are used interchangeably unless context suggest otherwise or warrants a particular distinction among such terms. A blending process may include a series or sequence of blender settings and operations to be carried out by the blending device. In an aspect, a blending process may include at least one motor speed and at least one time interval for the given motor speed. For example, a blending process may include a series of blender motor speeds to operate the blender blade at the given speed, a series of time intervals corresponding to the given motor speeds, and other blender parameters and timing settings. The blending process may further include a ramp-up speed that defines the amount of time the motor takes to reach its predetermined motor speed. The blending process may be stored on a memory and recalled by or communicated to the blending device (e.g., in response to receiving user input or the like).

In addition, blending of foodstuff or ingredients may result in a blended product. Such blended products may include drinks, frozen drinks, smoothies, shakes, soups, purees, sorbets, butter (e.g., nut butter), dips or the likes. It is noted that various other blended products may result from blending ingredients. Accordingly, terms such as “blended product” or “drink” may be used interchangeably unless context suggests otherwise or warrants a particular distinction among such terms. Further, such terms are not intended to limit possible blended products and should be viewed as examples of possible blended products.

Described herein is a sound reducing system for blenders. The sound reducing system may be used to capture sound and/or vibration from a blender during a blending process, analyze the captured sound and/or vibration, and control the speed, pattern, and general mixing provided by the blender to adjust the emitted sound and/or vibration from the blender. It is noted that the sound reducing system may be fully integrated into a blender unit, may be partially integrated in a blender unit (e.g., controller within the blender, microphone or accelerometer near the blender), or fully separate from the blender (e.g., separate device(s) that communicate with the blender through a wired or wireless connection) and the like, as may be adapted and desired. It is also noted that the terms sound and vibration may generally be used interchangeably and that one term may be used to refer to both terms unless context or this disclosure suggests otherwise.

In certain embodiments, it may desired by users of blenders or may be otherwise be advantageous to reduce the sound emissions from the blender. In certain embodiments, the rotational speed of the motor and/or blender blade may be a key factor in how loud a blender sounds. In certain embodiments, certain frequencies of the sound signature from a blender can be more offensive to users and may not be directly correlated to total output sound pressure of the blender.

Common methods to reduce sound output of blenders may include, but are not limited to dampening vibrational energy, making balanced parts that are rotating, eliminating resonant and amplifying structures within the blender and absorbing the sound energy being emitted via the use of foams and other sound absorbing and/or blocking components. Nevertheless, traditional methods of operation of typical kitchen appliances are often geared toward the production of a final result, with the amount of acoustic noise generated as a result taken as a lower priority operational feature.

Aspects of systems, methods, apparatuses or processes described herein generally relate to a sound recognition and/or reduced sound systems and methods for a blender. In an embodiment, the systems and methods may capture and analyze sound and/or vibration of the blending system and that adjusts one or more aspects of the blending system to reduce the sound and/or vibration based on the captured information to provide feedback control.

In an embodiment, the system may sense the amount of energy being emitted by the blender (e.g., as sound and/or vibration). In an embodiment, the system may thereby control the rotational speed of the motor as a function of sound and/or vibration emission. In an embodiment, the system may dynamically control the motor speed, pattern, or other aspect of the blending process to keep the sound and/or vibration output within set limits. In an embodiment, such control may further optimize the blending performance of the blender. In an embodiment, varying the motor speed as a function of certain resonant frequencies (e.g., as sound and/or vibration) may allow for increasing motor speed to lower the output amplitude of those frequencies generated due to resonant response. The system may be used to capture, analyze, identify, and adjust acoustic output of a blender during a blending process. In certain embodiments, the system may then, reduce the energy being emitted by the blender (e.g., as sound and/or vibration) through operational adjustments, without adding dampening components which may thereby increase the size, complexity, weight, thermal impedance, and/or the like of the blender.

The systems and methods may include a capture component that may capture or otherwise receive an audio signal. For instance, the capture component may include and/or communicate with a microphone that may receive an audio signal. For instance, the capture component may include and/or communicate with an accelerometer that may receive an audio signal. In another aspect, the systems and methods may include an analysis component that may analyze captured audio and may determine an aspect of the captured audio (e.g., decibels, loudness, etc.). The analysis component may identify or represent interest points. The analysis component may compare the captured audio to a threshold parameter (e.g., desired decibels, loudness, etc.). The comparison may determine if the sound of the system should be reduced (e.g., the captured audio is greater than the threshold parameter) and by how much (e.g., 100%, 20%, etc. to be under the threshold parameter). In some examples, the capture component and analysis component may iterate measuring sound and reducing speed until measured sound is below a threshold parameter. The library component may store recipes and quiet programs, and may save user preferences based on past user input. The library component or other component may further house various reference sample sound and/or vibration emissions or fingerprints that may be used to analyze the captured sound emissions and determine appropriate adjustment in blending operation.

In an example, a user may operate a blending system to blend foodstuff. During a blending process, a blending device may emit sound and/or vibration. A device, such as a user device or a blender, may capture the sound and/or vibration. A user may input operating parameters that define or describe the blending system, ingredients, a user's observations of a blending process, and/or a blending process. For instance, the user may identify a make/model of blending device, ingredients added, blending process selected, blender settings, or the like, as well as whether a quiet mode is desired.

In an embodiment, as a blender motor operates, it may excite the structural components of the blender as a result of the fundamental rotational speed of the blender motor. These excitations can cause resonant responses of said structural components within the blender, which are eventually emitted as acoustic energy into the environment. In an embodiment, as the blender operates, there are other components in the system, which may emit acoustic energy as a function of their basic operation, for example, the blender blade creates pressure waves within the blender container, which are emitted into the environment through the sidewalls of the blender container. The provided system can sense these acoustic regimes and adjust the speed of the motor to affect their amplitude.

In an embodiment, limits on acoustic output can be established and saved within the system as a means to provide input to the motor controller which further establishes and controls the rotational speed of the motor. In the case where the basic rotational speed of the motor engages a resonant frequency of a component, it may actually be advantageous to increase the motor speed to de-tune the resonant frequency of said component.

In an embodiment, sensing of the output sound pressure can be accomplished by using a microphone to detect and measure the amplitude of the output sound pressure, as well as using vibrational sensors and accelerometers to detect the resonant response of components within the blender. In an embodiment, a vibrational characterization of the blender can be accomplished and stored as a means to avoid certain rotational speeds of the blender, which result in excessive modal excitations. This can also be done periodically by putting the blender into a “learn mode” which allows it to control its own speed and map the key output vibrational peaks and their corresponding motor speed excitations. In an embodiment, certain output frequencies may be perceived by the user as objectionable, and can be avoided as a result of controlling the speed of the blender motor. In an embodiment, blender noise can be a function of container contents being moved around in the container, in particular, a pulsation/variation in the sound output can be noticed as a result of container contents being thrown up which results in a change in motor speed due to load change. By monitoring the sound and motor speed together and allowing the blender to “learn,” the system can include predictive controls to anticipate these pulsations and cancel or reduce them in amplitude.

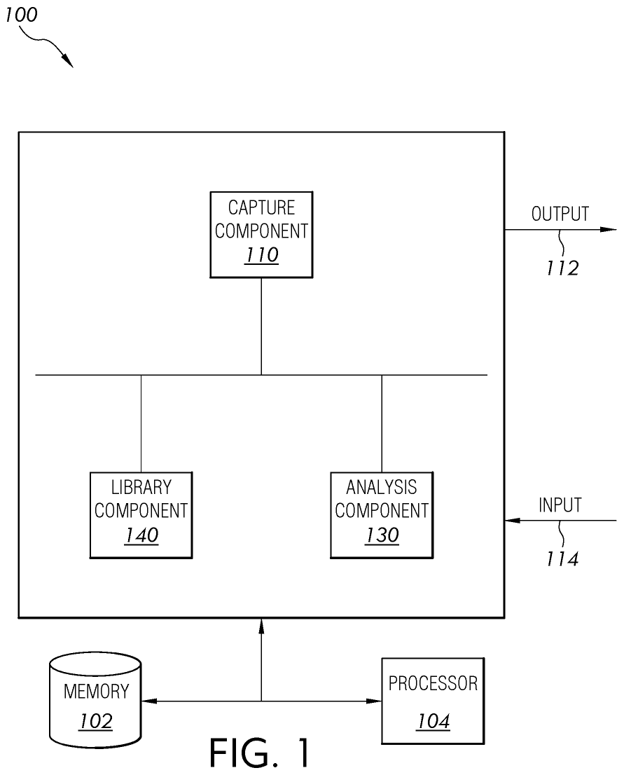

Referring now to FIG. 1, depicted is a block diagram of an illustrative system 100 that provides quiet or reduced sound blending, according to various aspects. The system 100 includes a memory 102 and processor 104. The memory 102 may be configured to store computer executable components such as a capture component 110, an analysis component 130, and a library component 140. The processor 104 may facilitate operation of the computer executable components. It is noted that the system 100 may include one or more devices, such as a user device and/or a blending device or system may be a fully integrated into a blender or into an external system. It is further noted that one or more devices may include, at least in part, the various components. For instance, a single component of the system 100 may be included by one or more devices (e.g., an end-user device, a technician device, etc.). While shown as separate or distinct components, the components of the system 100 may be included by one or more components.

The capture component 110 may generally be any device configured to monitor and capture audio signals. In at least one embodiment, the capture component 110 may include a microphone, such as a microphone of a user device (e.g., a MEMS microphone) or a microphone may be positioned in, on, or near a blender base, blender container, or blender. In an embodiment, the microphone may be built onto a PCB control system of machine blender device. The microphone may measure sound as the blender is being used. In at least one embodiment, the capture component 110 may include an accelerometer, such as an accelerometer of a user device or an accelerometer may be positioned in, on, or near a blender base, blender container, or other portions of the system 100. The accelerometer may measure vibration as the blender is being used. It is noted that the capture component 110 may be both an integrated component of the blender or blending system (or an adaptable component that can be used to modify existing blenders or blending systems) or a user device such as a smart phone or smart watch.

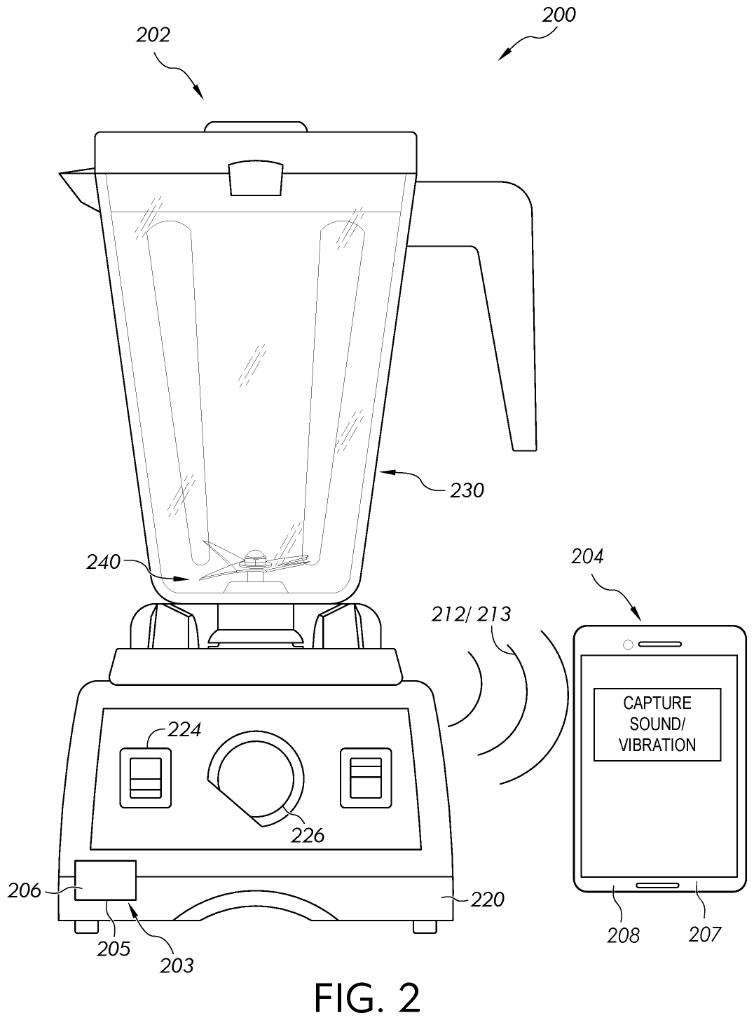

Turning now to FIG. 2 with reference to FIG. 1, depicted is a blending system 200 that includes a blending device 202 and an integrated capture component 203. It is noted that various components of the system 100 may be included by the blending device 202 and/or the user device 204 or the integrated capture component 203. In an example, the capture component 203 may include a microphone 206 may be provided as part of the integrated capture component 203. In another example, a microphone 207 may be part of a user device 204 (e.g., a remote device) and communicatively coupled to blending system 200. It is noted that an accelerometer 205 may be provided instead or in addition to the microphone 206. In an example, an accelerometer 208 may be part of the user device 204 and communicatively couple to blending system 200. The integrated microphone 206 and/or user device microphone 207 may receive and process the audio signals 212 as an input 114 from blending device 202 (e.g., via an airway or other carrier of a sound wave). The integrated microphone 206 and/or the user device microphone 207 may include and/or be coupled to a transducer (not shown) that transduces the received audio signals into representative electronic signals. It is noted that capture component 203 may utilize a plurality of microphones to improve reception and/or filter noise. The integrated accelerometer 205 and/or the user device accelerometer 208 may receive and process vibration 213 as input 114 from blending device 202 (e.g., via an airway or other carrier of vibration). The integrated accelerometer 205 and/or the user device accelerometer 208 may include and/or be coupled to a transducer (not shown) that transduces the received vibration into representative electronic signals. It is noted that the capture component 203 may utilize a plurality of accelerometers to improve reception and/or filter vibration. It is noted that the capture component 203 (e.g., capture component 110) may utilize one or more additional or alternative sensors, for example, an acoustic sensor, a pressure sensor, and/or a vibrational sensor configured to capture one or more aspects of an acoustic output.

The blending device 202 may generate noise and/or vibration as a result of operation of a motor (not shown), agitation of food stuff, etc. The motor may be housed within a blender base 220. The blender base 220 may operatively engage with a blending container 230, and/or a blade assembly 240 (e.g., may interlock with the blending container 230 to maintain a positioning of the blending container 230 during operation, and/or may interlock with the blade assembly 240 to drive the blade assembly during operation). A user may interact with one or more input devices (e.g., knob 226, switch 224, etc.) to provide input to operate the motor. The motor may be operatively engaged with the blade assembly 240, which may be disposed within the blending container 230. Operation of the motor may cause rotation of the blade assembly 240. In an example, a user may add ingredients to the blending container 230, and the blade assembly 240 may chop, blend, or otherwise process the ingredients. Operation of the blending device 202 may generally produce noise (e.g., audio signals 212) and/or vibration (e.g., vibration 213) which may be captured by the integrated microphone 206 and/or the integrated accelerometer 205, and/or the user device microphone 207 and/or the user device accelerometer 208.

In an aspect, the capture component 110 (e.g., capture component 203) may include a transducer that may convert captured audio signals and/or vibration to an electrical representation thereof. An analysis component 130 may be included and used generate a fingerprint, spectrogram, or other representation of the received electronic signal. The fingerprint may be used by the analysis component 130 to compare the captured information to threshold parameters. According to at least one embodiment, an entire spectrogram of audio/vibration captured from a blending process may include large amounts of data and may be difficult to process, such as for comparing spectrograms with each other. Thus, an analysis component 130 may generate compact descriptors (“fingerprints”) of captured audio/vibration. In an example, an analysis component 130 may generate a fingerprint that represents or identifies the captured audio/vibration signal.

In an aspect, the fingerprint may include or describe information over a period of time, such as amplitude and/or intensity of a frequency at various times. It is noted that filters may be utilized to filter-out or remove certain frequencies from an audio/vibration signal. For instance, band-pass filters, or other filters may remove some sound generated by a motor (e.g., normal operating sounds), remove background noise (e.g., a user speaking), isolate frequencies (e.g., those most likely to help identify an issue), or the like.

In another aspect, the fingerprint may include a combination of frequency measurements over time. It is noted that various processes may be utilized to generate a fingerprint such as processes employing Fourier transforms, wavelet transforms, interest point recognition, or the like. Identifying or calculating an interest point may include identifying unique characteristics of fingerprints and/or audio signals. For instance, calculating fingerprints may include calculating interest points that identify unique characteristics of a time-frequency representation of captured audio/vibration. Fingerprints may then be generated as functions of sets of interest points. Interest points may include a spectral peak of a frequency over a period of time, timing of the onset of a frequency, or any suitable event over a duration of time.

The analysis component 130 may utilize a generated fingerprint (or other representations of audio/vibration signals) and may compare the audio/vibration signals to threshold parameter. The threshold parameter, for example, may be a certain level of sound or vibration (e.g., decibels) that is considered a maximum sound or vibration. The threshold parameter may vary based on the step of the blending process, ingredients, recipe, etc. or may be inputted by a user as a customized level. The analysis component 130 may analyze captured audio/vibration from the capture component 110 and may determine an aspect of the captured audio/vibration (e.g., decibels, loudness, etc.). The analysis component 130 may identify or represent interest points. The analysis component 130 may compare the captured audio to a threshold parameter (e.g., desired decibels, loudness, etc.). The comparison may determine if the sound of the system should be reduced (e.g., the captured audio is greater than the threshold parameter) and by how much (e.g., 100%, 20%, etc. to be under the threshold parameter). The analysis component 130 may generate an output 112 indicating one or more adjustments to the system, for example, increasing or decreasing the power of the motor of the blending system.

The library component 140 may store recipes and quiet programs, and may save user preferences based on past user input. In some examples, the analysis component 130 may utilize a step down function that generates an output 112 to step down power/speed of the motor, then instructs the capture component 110 to iterate capturing of audio. The analysis component 130 may continue to generate output 112 to step down the power/speed of the motor until the capture component 110 captures audio below a threshold level. It is noted that the analysis component 130 may identify a minimum power/speed for the motor. If this minimum is reached, the analysis component 130 may terminate the step down function. According to at least some embodiments, the analysis component 130 may store power/speed of the motor at which further step down was terminated. This stored power/speed may be used as a first speed/power at which to step down in future blending programs. It is noted that the analysis component 130 may use historic information, such as an average power/speed at which a target volume was reached for the ten most recent blends, and may base a first step down power/speed as a function thereof.

In an example, the user may place the user device 204 next to or near the blending device 202. The user may initiate a listening or monitoring process by providing input to the user device 204 or the blending device 202 (e.g., selecting “capture sound,” “quiet mode,” “learn mode,” etc.). The user may additionally initiate a blending process, such as by pressing the switch 224 and/or the knob 226. The blending process and/or listening process may continue for a predetermined amount of time or a dynamically amount of time (e.g., user determined, when blending process ends, etc.). As the blending process continues, the capture component 110 (e.g., capture component 203) may obtain sensor information including noise/vibration levels produced by blending food within a container. The analysis component 130 may evaluate the captured data and determine the acoustic output (e.g., the measured noise/vibration level) of the blending process. The analysis component 130 may further determine whether the acoustic output (e.g., measured noise/vibration level) satisfies a threshold parameter. An acoustic output satisfies a threshold parameter where the value of the acoustic output satisfies the threshold. For example, where the threshold parameter is a maximum threshold, the acoustic output satisfies the threshold when the acoustic output is less than the maximum. In another example, where the threshold parameter is a minimum threshold, the acoustic output satisfies the threshold when the acoustic output is greater than the minimum threshold. In yet another example, where the threshold parameter is a range, the acoustic output satisfies the threshold range when the acoustic output is outside (e.g., less than or greater than), the range. If the acoustic output satisfies the threshold parameter, the analysis component 130 may communicate to the system to alter a motor speed until the acoustic output is below the threshold parameter as confirmed by the capture component 110 and the analysis component 130. The threshold parameter may be a function of user input, a stored threshold, a learned threshold, ambient noise, etc. In examples, the threshold parameter may be stored in the library component 140.

In an example, the user may place the user device 204 removed from the blending device 202, for example, across a room from the blending device 202, in a different room from the blending device 202, or the like. The user may initiate a blending process using the blending device 202. The user may additionally initiate a listening or monitoring process, such as using the user device 204 or using the blending device 202. As the blending process continues, the capture component 110 may obtain sensor information including noise/vibration levels produced by blending food within a container. In some embodiments, the capture component 110 obtains the sensor information from user device 204, for example, via a wired or wireless connection. The analysis component 130 may evaluate the captured data and determine the acoustic output (e.g., the measured noise/vibration level) of the blending process. The analysis component 130 may further determine whether the acoustic output (e.g., measured noise/vibration level) satisfies a threshold parameter. If the acoustic output satisfies the threshold parameter, the analysis component 130 may communicate to the system (e.g., via a wired or wireless communication) to alter a motor speed until the acoustic output is below the threshold parameter as confirmed by the capture component 110 and the analysis component 130. The threshold parameter may be a function of user input, a stored threshold, a learned threshold, ambient noise, etc. In examples, the threshold parameter may be stored in the library component 140.

In accordance with various aspects of the subject specification, an example embodiment may employ classifiers that are explicitly trained (e.g., via a generic training data) as well as implicitly trained (e.g., via manual input, blending information, user preferences, historical information, receiving extrinsic information). For example, support vector machines may be configured via learning or training phase within a classifier constructor and feature selection module. Thus, the classifier(s) may be used to automatically learn and perform a number of functions, including but not limited to determining preferred sound/vibration level, maximum sound/vibration level, anticipated sound/vibration levels based on recipes and foods, and the like. This learning may be on an individual basis (e.g., based solely on a single user, blender, blender make/model, blending process) or may apply across a set of or the entirety of a base (e.g., a user base). Information from the users may be aggregated, and the classifier(s) may be used to automatically learn and perform a number of functions based on this aggregated information. The information may be dynamically distributed, such as through an automatic update, a notification, or any other method or means, to the entire user base, a subset thereof or to an individual user.

In an example, a user may provide operating parameters and/or blending device parameters as user input (e.g., input 114). In some embodiments, the user may interact with an interface of the user device 204. In some embodiments, the user may interact with an interface of the blending device 202. In at least one embodiment, the interface may be configured to prompt a user and/or receive input from the user. The interface may provide controls to receive an input pertaining to when a quiet mode and/or a learn mode is activated, such as a drop-down box, or the like. The blending process or operating parameters may be set via user controls. According to an aspect, the interface may include a graphical representation of a blender input device, such as graphical knob. A user may rotate the graphical knob to select a blending process for which quiet mode or learning mode is to be activated. This may allow the user to easily input blending parameters. In an example, the graphical knob may be rotated via a touch screen or other input mechanism. Interface may prompt a user to provide input associated with ingredients in the blending container 230. Prior to capturing audio, the user may select the ingredients that are input into the blending container 230 and/or quantities of the ingredients via desired user controls. It is noted that the types and/or quantities of the ingredients may be any appropriate type or quantity.

While a motor and/or blade assembly 240 is operating, a user may add additional ingredients, change blending speeds, pulse the motor, or the like This may result in changes to audio signals generated by the blending device 202. That is, the audio signals that are captured may be indicative of additional ingredients, a change in blending speed, a pulse of the motor or the like. For example, the addition of ingredients may cause the general characteristic of the interior of the blending container 230 to change, which in turn changes the type of sound that emanates from the blending container. In another example, if a user changes the blend speed, the pitch of the sound emanating from the motor may change as a result, thereby changing the audio signals that are detected. In at least one embodiment, a user may provide system 100 with a recipe that the user is following. This may allow analysis component 130 to associate variations in a fingerprint with user acts. Accordingly, the variations may be accounted for and/or compared to expected variations. According to at least one embodiment, system 100 may track or monitor user actions as a blending process is performed.

It is further noted that blender base 220 may communicate with components of the system via wireless and/or wired interfaces. For instance, blender base 220 and components of the system may communicate via a wireless protocol (e.g., Wi-Fi, BLUETOOTH, NFC, etc.). The blender base 220 may transmit operating parameters to components of the system. The operating parameters may include but are not limited to: a make/model of the blending device, sensor information (e.g., temperature, weight, vibration, etc.), information describing whether the blending device 202 is interlocked, information associated with a selected blending process, a motor speed setting, user input (e.g., user selections), or the like. It is noted that a blending system 200 may automatically determine and/or detect ingredients added to the blending container 230, quantities added, or the like. Components of the system may be used to communicate threshold parameters, e.g., those inputted by the user, to the blending device, and may be used to communicate to the blending device 202 that the user has initiated a quiet mode, a learn mode, or blending.

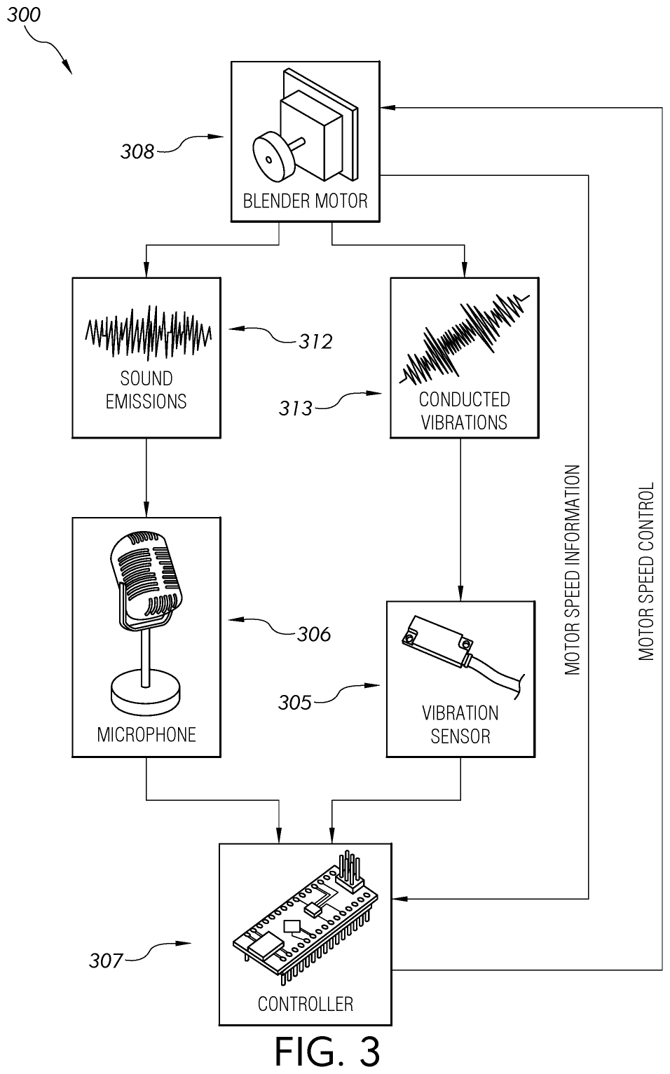

Turning to FIG. 3, shown is a system 300. The system 300 may actively control the motor and/or other noise generating components in a kitchen appliance (e.g., device 202 in FIG. 2) to limit the amount of acoustic sound 312 being generated by the kitchen appliance. The system 300 may actively control the motor and/or other noise generating components in a kitchen appliance to limit the amount of vibrational energy 313 being generated by a kitchen appliance. The system 300 may include one or more sensors, e.g., microphone sensor 306, or vibration sensor 305, to detect the acoustic sound 312 or vibrational energy 313 being emitted by the appliance (e.g., blender motor 308) during operation and use this in a feedback loop to alter the rotational speed, blending pattern, etc. of the blender motor 308 being used to drive the appliance.

The system 300 may include an established or variable upper limit (e.g., a maximum threshold parameter) to the amount of acceptable acoustic or vibrational output and the controller may adjust the rotational speed, blending pattern, etc. of the motor to keep the sound within the defined limits. In the case where higher rotational speeds result in a higher level of output, the method to limit the acoustic or vibrational output may include lowering the rotational speed until an upper limit of output has been achieved. Lowering the rotational speed may be associated with a longer appliance operational times in order to achieve the same final result of blended product. In some cases, the rotational speed of the appliance motor may excite or stimulate modal frequencies or components in the appliance, which can result in higher acoustic output. The rotational speed(s) of the applicant motor which correspond to the modal frequencies or components resulting in higher acoustic output may be indicated at excitational speed(s). In this case, it may be advantageous to increase or decrease the speed of the motor to move away from the excitational speed, which is creating the modal response. For example, the system 300 may include an established or variable range (e.g., a threshold parameter range) of acceptable acoustic or vibrational output, such as based on the modal frequencies or components which result in higher acoustic output, and the controller is configured to increase or decrease the motor speed, thereby reducing the acoustic output. In some embodiments, analysis component 130 is further configured to determine an adjustment to the blending time, for example, an increase or decrease in appliance operational time in order to achieve the same final resultant blended product, such as where there is an increase or decrease in the motor speed.

The system 300 may include an intelligent motor controller 307 that can be provided with information from vibrational and/or acoustic sensors (e.g., microphone sensor 306 and/or vibration sensor 305) as an input to a control algorithm which in turn adapts and controls the motor rotational speed as a means to limit the amount of acoustical or vibrational output within established or variable limits.

The system 300 may include a variety of functions as a result of varying the processing algorithm which controls the system. For example, the system 300 may include and utilize machine learning. In an embodiment, for example, in a learning mode, the appliance may be driven through its normal operational speed range and a survey made of both modal vibrational and acoustic response. Using the device through its operational speed range may excite certain modal responses, which can be utilized in a learning algorithm as a means to anticipate and/or avoid these model responses as a means to limit objectionable acoustic and/or vibrational outputs. Further, there may be certain combinations of ingredients and raw materials that are normally processed by an appliance that may create cyclic or other non-periodic acoustic or vibrational outputs as the ingredients move about in their processing container.

In the case of a blender, this may take the form of “glugging” as the ingredients incorporate a pocket of air around the blade, which is suddenly released, resulting in the ingredients dropping and re-contacting the blade. This can be very cyclic and can be a function of motor rotational speed and can create a very definable and objectionable sound. The system 300 may be used to avoid, prevent, or minimize this acoustic sound by actively adjusting the speed of the motor to prevent the accumulation of an air pocket.

The blender may also “freeze-up”, which is produced by an accumulation of air or non-uniformly loose ingredients around the blade which does not get released. The system 300 may be used to avoid, prevent, or minimize this acoustic sound by actively monitoring the acoustic output of the blender and adjusting the speed of the motor to assist in the release of the air pocket. This speed adjustment may include a complete turning off of the motor to allow the air pocket to escape.

Cavitation may similarly produce a unique sound profile, such as a high-pitched sound. The system 300 may be used to monitor a blending process to determine if certain undesirable noise is occurring or likely to occur, adjust the blending process to avoid such undesirable noise, and learn for future blending processes to continue to or better minimize or avoid such noise.

In the case where the appliance is outfitted with a reversible motor, other conditions which can be sensed acoustically or vibrationally can alleviated or minimized by a complete reversal of motor rotational direction. Among other potential methods, this sensing may include monitoring the power consumption of the motor and correlating it to predetermined or sensed acoustic or vibrational outputs and altering the motor speed as a result.

In some embodiments, the system 300 may utilize remote sensing, for example, through a remote device. For example, one or more of the acoustic or vibrational sensors can also be located remotely to the appliance and the measurements of environmental acoustic or vibrational energy can be utilized as a sole or additional input to the processing algorithm to determine the allowable operational motor speeds. This could be implemented via the utilization of the microphone and vibrational sensors found in a common smart phone and communicated to the appliance via the phone's wireless communications capability. This wireless capability could take the form of a WI-FI or Bluetooth connection between the smart phone and appliance.

In some embodiments, a remote device may communicate with the appliance through the use of ultrasonic communications, which can alleviate the need for the smart phone or remote sensing capability to be “paired” with the appliance. In this embodiment, the remote sensor can sense the emitted acoustic or vibrational output and emit an ultrasonic tone that had data encoded within it in response, and the appliance would “listen” for these tones using its built-in acoustic sensing capability and significantly simplify the interaction of a user with the appliance. The appliance can then decode the ultrasonic tones and data contained within, and use this as an input to its speed control algorithm.

In some embodiments, a threshold parameter may be based on environmental acoustics or background noise pressure. As described herein, appliances may emit acoustic energy as a result of their operation. For example, motor rotational speed can affect the acoustic and vibrational output of a blender. The objectionableness of this energy to a user may be based on the environmental conditions of the appliance, for example, the amount of pre-existing background noise pressure. For example, the more background noise that may exist, the less objectionable certain sounds may be, such as compared to if the same sound were to occur with little background noise. In some cases, if the amount of noise emitted from the appliance does not exceed, or significantly exceed the level of background noise pressure, the level of objectionableness may be diminished. The system 300 may sense the level of background noise and provide this as an input to the processing algorithm, which may provide an increased limit to the amount of acoustic energy an appliance could emit without exceeding the limits of objectionableness. For example, one or more sensors associated with the system 300, such as microphone sensor 306 or vibration sensor 305, may sense the environmental acoustic conditions of the blender. In some cases, the threshold parameter may be adjusted based on the environmental acoustic conditions of the blender, for example, an increased limit where the background noise is at an increased level. As another example, the threshold parameter may be a decreased limit where the background noise is at a decreased level.

As described, the system 300 may include processors and motor controllers to capture sound and/or vibration and regulate the operational speed of a motor. The system 300 may include sensing capabilities to provide inputs to processing algorithms designed to control the amount of vibrational or acoustic energy being emitted by the appliance during operation. The limits of acoustic or vibrational output can be either predetermined and preset at the factory, or can be a result of including a user interface that allows for the input of dynamic and/or variable control over maximum limits by a user. For example, one or more limits may be a threshold parameter for the system 300.

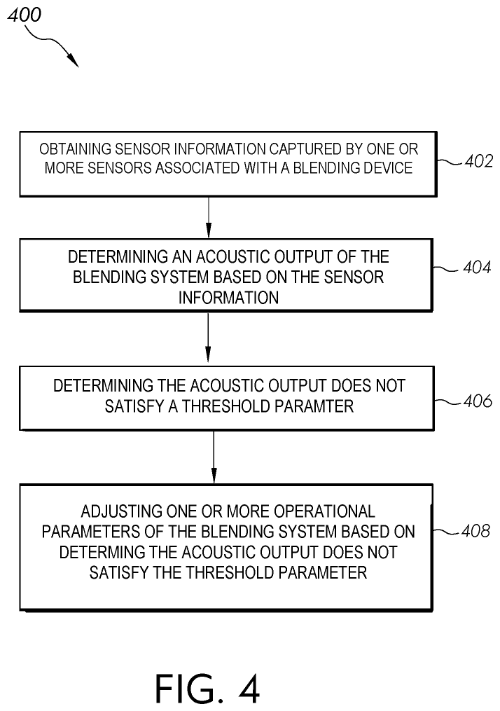

The described systems may utilize various techniques to identify issues based on captured audio and/or operating parameters. What has been described above are exemplary embodiments that may facilitate providing quiet or reduced sound blending processes and devices. In view of the subject matter described herein, methods that may be related to various embodiments may be better appreciated with reference to the flowchart of FIG. 4. While the method is shown and described as a series of blocks, it is noted that associated methods or processes are not limited by the order of the blocks. It is further noted that some blocks and corresponding actions may occur in different orders or concurrently with other blocks. In addition, different blocks or actions may be utilized to implement the method described hereinafter. Various actions may be completed by one or more of users, mechanical machines, automated assembly machines (e.g., including one or more processors or computing devices), or the like.

FIG. 4 depicts an example flowchart of non-limiting method 400. In an example, method 400 may include obtaining sensor information for example, audio or vibration from a blending device, captured by one or more sensors associated with a blending system at block 402. In some embodiments, the one or more sensors may include a microphone (e.g., microphone 306), an acoustic sensor, a pressure sensor, a vibration sensor (e.g., vibration sensor 305), or an accelerometer. In some embodiments, obtaining the sensor information captured by the one or more sensors associated with the blending system includes receiving an indication of the sensor information from a remote device.

At block 404, method 400 may further include determining an acoustic output of the blending system based on the sensor information, wherein the acoustic output includes a sound pressure output associated with the blending system. In some embodiments, the acoustic output of the blending system further includes at least one of: an acoustic signature, a frequency of a source output, or a vibration output associated with the blending system.

At block 406, method 400 may further include determining the acoustic output does not satisfy a threshold parameter. In some embodiments, determining the acoustic output does not satisfy the threshold parameter includes comparing the acoustic output to the threshold parameter, and determining the acoustic output is greater than the threshold parameter. In some embodiments, determining the acoustic output does not satisfy the threshold parameter includes comparing the acoustic output to the threshold parameter, and determining the acoustic output is less than the threshold parameter. In some embodiments, determining the acoustic output does not satisfy the threshold parameter includes comparing the acoustic output to the threshold parameter, and determining the acoustic output is not equal to the threshold parameter.

In some embodiments, the threshold parameter is based on one or more characteristics of the blending system, wherein the one or more characteristics include at least one of: a model of the blending system, a blending process, or one or more blender settings. In some embodiments, the threshold parameter is based on one or more reference samples. In some embodiments, method 400 further includes obtaining environmental information associated with one or more environmental conditions of the blending system, and the threshold parameter is based on the one or more environmental conditions of the blending system. In some embodiments, method 400 further includes obtaining ingredient information associated with one or more ingredients within a container of the blending system and the threshold parameter is based on the one or more ingredients within the container.

At block 408, method 400 may further include adjusting one or more operational parameters of the blending system based on determining the acoustic output does not satisfy the threshold parameter. In some embodiments, adjusting the one or more operational parameters of the blending system includes pulsing a power of a motor associated with the blending system. In some embodiments, adjusting the one or more operational parameters of the blending system includes increasing or decreasing a power of a motor associated with the blending system. In some embodiments, adjusting the one or more operational parameters of the blending system includes adjusting a blending time associated with the blending system.

In some embodiments, method 400 further includes receiving an indication to initiate a quiet blending mode associated with the blending system, wherein the sensor information is obtained in response to the indication to initiate the quiet blending mode. In some embodiments, method 400 further includes receiving an indication to initiate a learn mode associated with the blending system, wherein the sensor information is obtained in response to the indication to initiate the learn mode; and mapping the acoustic output to a corresponding power of a motor associated with the blending system.

In certain embodiments, method 400 reduces an acoustic output of a blending system, for example, pressure, resonate frequency, objectionable frequency, vibration, noise, and/or the like, by adjusting one or more operational parameters of the blending system. Aspects of method 400 reduce acoustic output of the blending system, thereby improving the blending operation experience, without degrading the blended product. Further, aspects of method 400 may selectively reduce aspects of the blending system's acoustic output by increasing or decreasing motor speeds to adjust the blending system operations out of undesirable acoustic output, for example, resonant frequency, pressure, and/or the like, associated with the blending system. In addition, the acoustic output of the blending system may be reduced through operational adjustments, without adding dampening components which may thereby increase the size, complexity, weight, thermal impedance, and/or the like of the blending system.

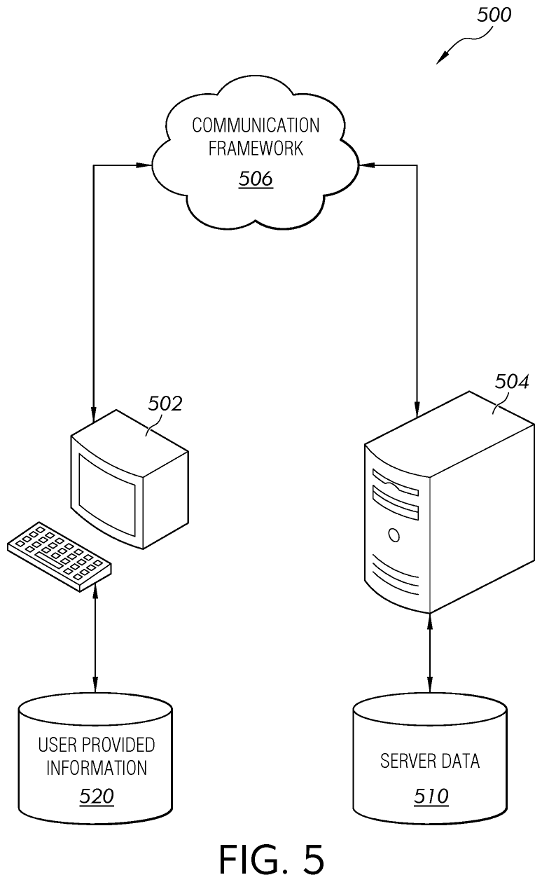

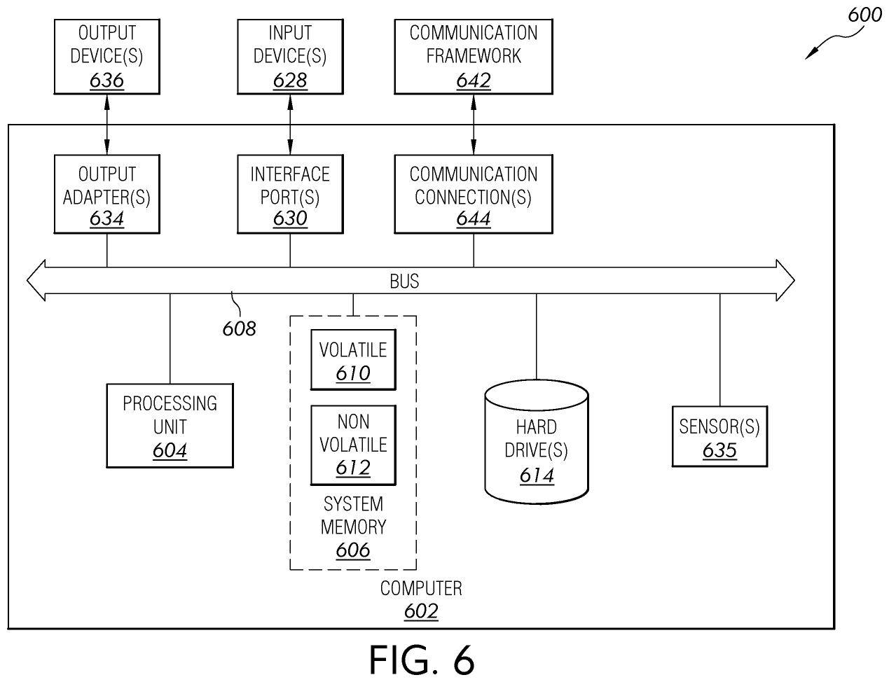

What has been described above may be further understood with reference to the following figures. FIGS. 5-6 provide exemplary operating environments or systems capable of implementing one or more systems, apparatuses, or processes described above. FIGS. 5-6 are not intended to limit the scope of such systems, apparatuses, or processes. By way of example, computing environment 500 may refer to one or more embodiment of the various embodiments described with reference to the above figures. However, variations to computing environment 500 may be obvious to achieve aspects or processes described herein.

FIG. 5 is a schematic diagram of a computing environment 500 in accordance with various disclosed aspects. It is noted that computing environment 500 may include various other components or aspects. As depicted, computing environment 500 may include one or more client(s) 502, one or more server(s) 504, one or more client data store(s) 520, one or more server data store(s) 510, and a communication framework 506.

While depicted as a desktop computer(s), client(s) 502 may include various other devices that may include hardware and/or software (e.g., program threads, processes, computer processors, non-transitory memory devices, etc.). In an example, client(s) 502 may include laptop computers, smart phones, tablet computers, blending devices, wearables, etc.). The client(s) 502 may include or employ various aspects disclosed herein. For example, client(s) 502 may include or employ all or part of various systems (100, 200, 300, etc.) and processes (e.g., method 400, etc.) disclosed herein.

Likewise, server(s) 504 may include various devices that may include hardware and/or software (e.g., program threads, processes, computer processors, non-transitory memory devices, etc.). Server(s) 504 may include or employ various aspects disclosed herein. For example, server(s) 504 may include or employ all or part of various systems (100, 200, 300, etc.) and processes (e.g., method 400, etc.) disclosed herein. It is noted that server(s) 504 and client(s) 502 may communicate via communication framework 506. In an exemplary communication, client(s) 502 and server(s) 504 may utilize packeted data (e.g., data packets) adapted to be transmitted between two or more computers. For instance, data packets may include coded information associated with blending processes, sound/vibration information, or the like.

Communication framework 506 may include various network devices (e.g., access points, routers, base stations, etc.) that may facilitate communication between client(s) 502 and server(s) 504. It is noted various forms of communications may be utilized, such as wired (e.g., optical fiber, twisted copper wire, etc.) and/or wireless (e.g., cellular, Wi-Fi, near-field communication, etc.) communications.

In various embodiments, client(s) 502 and server(s) 504 may respectively include or communicate with one or more client data store(s) 520 or one or more server data store(s) 510. The data stores may store data local to client(s) 502 or server(s) 504.

In at least one embodiment, a client of client(s) 502 may transfer data describing a fingerprint, user account data, sound/vibration levels, or the like to a server of server(s) 504. The server may store the data and/or employ processes to alter the data. For example, the server may transmit the data to other clients of client(s) 502.

FIG. 6 is a block diagram of a computer system 600 that may be employed to execute various disclosed embodiments. It is noted that various components may be implemented in combination with computer executable instructions, hardware devices, and/or combinations of hardware and software devices that may be performed by a computer system 600.

The computer system 600 may include various components, hardware devices, software, software in execution, and the like. In embodiments, computer system 600 may include controller 602. The controller 600 may include a system bus 608 that couples various system components. Such components may include a processing unit(s) 604, system memory device(s) 606, disk storage device(s) 614, sensor(s) 635, output adapter(s) 634, interface port(s) 630, and communication connection(s) 644. One or more of the various components may be employed to perform aspects or embodiments disclosed herein. It is noted that one or more components of FIG. 6 may be included in different or other devices. For instance, the sensors(s) 635 may be disposed in a blender base or a user device. In an example, a blender base may include one or more of a temperature sensor, vibration sensor, or the like. The temperature sensor may sense parameters of the blender base, such as a temperature of a motor or temperature of other components. The blender base may communicate the sensed parameters to a user device (e.g., as input 114) and the user device may utilize the received input to determine whether the sound/vibration level exceeds a threshold parameter and whether the motor of the blender, for example, should be reduced to provide reduced sound/vibration.

In an aspect, the computer system 600 may “learn,” such as described above user preferences based upon modifications of recipes by users, through rating of recipes both positively and negatively. For example, the computer system 600 may modify a particular blending process as the majority of users or supermajority thereof have disapproved of the blending process or the like. The computer system 600 may dynamically push out the revised recipe or receive the revised recipe as applicable.

Processing unit(s) 604 may include various hardware processing devices, such as single core or multi-core processing devices. Moreover, processing unit(s) 604 may refer to a “processor,” “controller,” “control system,” “computing processing unit (CPU),” or the likes. Such terms generally relate to a hardware device. Additionally, processing unit(s) 604 may include an integrated circuit, an application specific integrated circuit (ASIC), a digital signal processor (DSP), a field programmable gate array (FPGA), a programmable logic controller or control system (PLC), a complex programmable logic device (CPLD), a discrete gate or transistor logic, discrete hardware components, or the likes.

The system memory 606 may include one or more types of memory, such volatile memory 610 (e.g., random access memory (RAM)) and non-volatile memory 612 (e.g., read-only memory (ROM)). ROM may include erasable programmable ROM (EPROM), electrically erasable programmable ROM (EEPROM). In various embodiments, processing unit(s) 604 may execute computer executable instructions stored in system memory 606, such as operating system instructions and the like.

The controller 602 may also be one or more hard drive(s) 614 (e.g., EIDE, SATA). While hard drive(s) 614 are depicted as internal to controller 602, it is noted that hard drive(s) 614 may be external and/or coupled to controller 602 via remote connections. In addition, input port(s) 630 may include interfaces for coupling to input device(s) 628, such as disk drives. The disk drives may include components configured to receive, read and/or write to various types of memory devices, such as magnetic disks, optical disks (e.g., compact disks and/or other optical media), flash memory, zip drives, magnetic tapes, and the like.

It is noted that hard drive(s) 614 and/or other disk drives (or non-transitory memory devices in general) may store data and/or computer-executable instructions according to various described embodiments. Such memory devices may also include computer-executable instructions associated with various other programs or modules. For instance, hard drives(s) 614 may include operating system modules, application program modules, and the like. In addition, aspects disclosed herein are not limited to a particular operating system, such as a commercially available operating system.

Input device(s) 628 may also include various user interface devices or other input devices, such as sensors (e.g., microphones, pressure sensors, light sensors, temperature sensors, vibration sensors, etc.), scales, cameras, scanners, facsimile machines, and the like. A user interface device may generate instructions associated with user commands. Such instructions may be received by controller 602. Examples of such interface devices include a keyboard, mouse (e.g., pointing device), joystick, remote controller, gaming controller, touch screen, stylus, and the like. Input port(s) 630 may provide connections for the input device(s) 628, such as via universal serial ports (USB ports), infrared (IR) sensors, serial ports, parallel ports, wireless connections, specialized ports, and the like. In an exemplary embodiment, the input device(s) 628 may be included in portions of a blending system. For example, sensors (e.g., temperature, vibration, weight, etc.) may be disposed in a blender base or a container. The controller 602 may receive input from the sensors and may determine whether the sound/vibration level exceeds a threshold parameter based at least in part on the received input. It is further noted that some input device(s) 628 may be included within a user device, such as a smart phone. As an example, a smart phone may include a microphone.

Output adapter(s) 634 may include various devices and/or programs that interface with output device(s) 836. Such output device(s) 636 may include LEDs, computer monitors, touch screens, televisions, projectors, audio devices, printing devices, or the likes.

In embodiments, the controller 602 may be utilized as a client and/or a server device. As such, the controller 602 may include communication connection(s) 644 for connecting to a communication framework 642. Communication connection(s) 644 may include devices or components capable of connecting to a network. For instance, communication connection(s) 644 may include cellular antennas, wireless antennas, wired connections, and the like. Such communication connection(s) 644 may connect to networks via communication framework 642. The networks may include wide area networks, local area networks, facility or enterprise wide networks (e.g., intranet), global networks (e.g., Internet), satellite networks, and the like. Some examples of wireless networks include Wi-Fi, WI-Fi direct, BLUETOOTH™, Zigbee, and other 802.XX wireless technologies. It is noted that communication framework 642 may include multiple networks connected together. For instance, a Wi-Fi network may be connected to a wired Ethernet network.

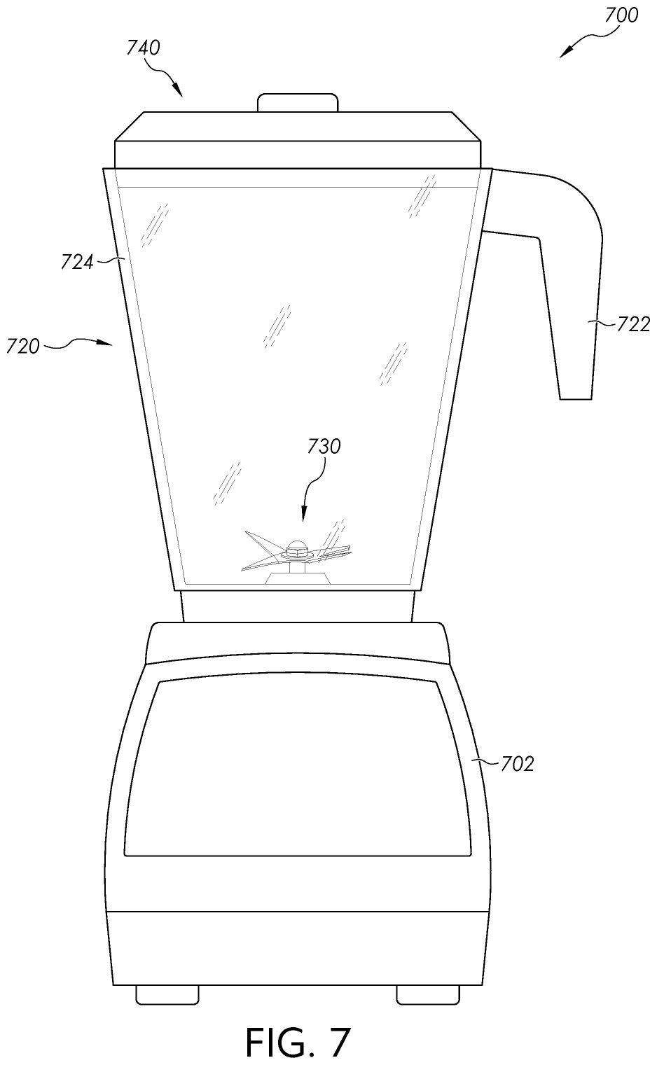

FIG. 7 illustrates an exemplary blending system 700 in accordance with various disclosed embodiments. The blending system 700 may utilize various disclosed aspects. For instance, the blending system 700 may include some or all portions of embodiments described with reference to FIGS. 1-6.

The blending system 700 includes a blender base 702, a container 720 operatively attachable to the blender base 702, a blade assembly 730, and a lid 740 that may be operatively attached to the container. The container 720 may include walls 724 and a handle 722. Foodstuff may be added to the container 720 for blending. It is noted that the container 720 may be formed of various materials such as plastics, glass, metals, or the like. In another aspect, the container 720 may be powered in any appropriate manner.

The blade assembly 730, the container 720, and the blender base 702 may removably or irremovably attach. The container 720 may be powered in any appropriate manner. For example, a power source may be configured to power the blending container. The power source may be positioned in the blending container and/or the blending base. The power source may be wireless. In examples, the power source may be an energy storage device, such as a rechargeable or nonrechargeable battery, a regenerative power supply, and/or the like. While shown as a large-format system, the blending system 700 may include a single serving style system, where the container is filled, a blender base is attached to the container, and then the container is inverted and placed on a base.

The blender base 702 includes a motor disposed within a housing. The motor selectively drives the blade assembly 730 (e.g., cutting blades, chopping blades, whipping blades, spiralizing blades, etc.). The blade assembly 730 may agitate, impart heat, or otherwise interact with contents within the container. Operation of the blending system 700 may impart heat into the contents within container 720.

In at least one embodiment, the blending system 700 may identify or detect whether the blending system 700 is interlocked through mechanical detection (e.g., push rods), user input, image recognition, magnetic detection (e.g., reed switches), electronic detection (e.g., inductive coils, a near field communication (NFC) component), or the like.

The blending system 700 and processes described herein generally relate to blending or food-processing systems include a food-processing disc including one or more inductive coils. In another aspect, one or more of the disc and/or lid may include an NFC component that may interact with an NFC component of a blender base. The NFC component of the blender base may receive information regarding the type of the disc and may utilize the blender base may utilize the information to determine a blending process to be utilized by the system.

It is noted that the various embodiments described herein may include other components and/or functionality. It is further noted that while described embodiments refer to a blender or a blender system, various other systems may be utilized in view of the described embodiments. For example, embodiments may be utilized in food processor systems, mixing systems, hand-held blender systems, various other food preparation systems, and the like. As such, references to a blender, blender system, and the like, are understood to include food processor systems, and other mixing systems. Such systems generally include a blender base that may include a motor, a blade assembly, and a control system. Further, such systems may include a container, a display, a memory or a processor.

As used herein, the phrases “blending process,” “blending program,” and the like are used interchangeably unless context suggest otherwise or warrants a particular distinction among such terms. A blending process may include a series or sequence of blender settings and operations to be carried out by the blending system 700. In an aspect, a blending process may include at least one motor speed and at least one time interval for the given motor speed. For example, a blending process may include a series of blender motor speeds to operate the blender blade at the given speed, a series of time intervals corresponding to the given motor speeds, and other blender parameters and timing settings. The blending process may further include a ramp up speed that defines the amount of time the motor takes to reach its predetermined motor speed. The blending process may be stored on a memory and recalled by or communicated to the blending device.

The terms “component,” “module,” “system,” “interface,” “platform,” “service,” “framework,” “connector,” “control system,” “controller,” or the like are generally intended to refer to a computer-related entity. Such terms may refer to at least one of hardware, software, or software in execution. For example, a component may include a computer-process running on a processor, a processor, a device, a process, a computer thread, or the likes. In another aspect, such terms may include both an application running on a processor and a processor. Moreover, such terms may be localized to one computer and/or may be distributed across multiple computers.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Each of the components described above may be combined or added together in any permutation to define the blending system 100. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Further aspects are provided by the subject matter of the following clauses:

A system for operating a sound reducing system, the system comprising: a blender comprising a motor; a capture component comprising one or more sensors configured to capture sensor information associated with the blender; and a controller communicatively coupled to the motor and the capture component, the controller configured to: obtain the sensor information captured by the one or more sensors; determine an acoustic output of the blender based on the sensor information, wherein the acoustic output comprises a sound pressure output associated with the blender; determine the acoustic output does not satisfy a threshold parameter; and adjust one or more operational parameters of the blender based on determining that the acoustic output does not satisfy the threshold parameter.

The system according to any preceding clause, wherein the one or more sensors comprise at least one of: a microphone, an acoustic sensor, a pressure sensor, a vibration sensor, or an accelerometer.

The system according to any preceding clause, wherein the acoustic output of the blender further comprises at least one of: an acoustic signature, a frequency of a sound output, or a vibration output associated with the blender.

The system according to any preceding clause, wherein the controller is further configured to obtain environmental information associated with one or more environmental conditions of the blender.

The system according to any preceding clause, wherein the threshold parameter is based on the one or more environmental conditions of the blender.

The system according to any preceding clause, wherein the controller is further configured to obtain ingredient information associated with one or more ingredients within a container of the blender.

The system according to any preceding clause, where in the threshold parameter is based on the one or more ingredients within the container.

The system according to any preceding clause, wherein in order to adjust the one or more operational parameters of the blender the controller is further configured to pulse a power of a motor associated with the blender.

The system according to any preceding clause, wherein the threshold parameter is based on one or more characteristics of the blender, wherein the one or more characteristics comprise at least one of: a model of the blender, a blending process, or one or more blender settings.

The system according to any preceding clause, wherein the threshold parameter is based on one or more reference samples.

The system according to any preceding clause, wherein in order to obtain the sensor information captured by the one or more sensors associated with the blender the controller is further configured to: receive an indication of the sensor information from a remote device.

The system according to any preceding clause, wherein in order to determine the acoustic output does not satisfy the threshold parameter, the controller is further configured to: compare the acoustic output to the threshold parameter; and determine the acoustic output is greater than the threshold parameter.

The system according to any preceding clause, wherein in order to determine the acoustic output does not satisfy the threshold parameter, the controller is further configured to: compare the acoustic output to the threshold parameter; and determine the acoustic output is less than the threshold parameter.

The system according to any preceding clause, wherein in order to determine the sensor information does not satisfy the threshold parameter, the controller is further configured to: compare the sensor information to the threshold parameter; and determine the sensor information is does not equal the threshold parameter.

The system according to any preceding clause, wherein in order to adjust the one or more operational parameters of the blender the controller is further configured to increase or decrease a power of a motor associated with the blender.

The system according to any preceding clause, wherein in order to adjust the one or more operational parameters of the blender the controller is further configured to adjust a blending time associated with the blender.

The system according to any preceding clause, wherein the controller is further configured to: receive an indication to initiate a quiet blending mode associated with the blender, wherein the sensor information is obtained in response to the indication to initiate the quiet blending mode.

The system according to any preceding clause, wherein the controller is further configured to: receive an indication to initiate a learn mode associated with the blender, wherein the sensor information is obtained in response to the indication to initiate the learn mode; and map the acoustic output to a correspond power of a motor associated with the blender.

A blender, the blender comprising: a motor; and a controller communicatively coupled to the motor, the controller configured to: obtain sensor information captured by one or more sensors associated with the blender; determine an acoustic output of the blender based on the sensor information, wherein the acoustic output comprises a sound pressure output associated with the blender; determine the acoustic output does not satisfy a threshold parameter; and adjust one or more operational parameters of the blender based on determining that the acoustic output does not satisfy the threshold parameter.

The blender according to any preceding clause, further comprising one or more sensors, wherein the one or more sensors comprise at least one of: a microphone, an acoustic sensor, a pressure sensor, a vibration sensor, or an accelerometer.

The blender according to any preceding clause, wherein the acoustic output of the blender further comprises at least one of: an acoustic signature, a frequency of a sound output, or a vibration output associated with the blender.

The blender according to any preceding clause, wherein the controller is further configured to obtain environmental information associated with one or more environmental conditions of the blender.

The blender according to any preceding clause, wherein the threshold parameter is based on the one or more environmental conditions of the blender.

The blender according to any preceding clause, wherein the controller is further configured to obtain ingredient information associated with one or more ingredients within a container of the blender.

The blender according to any preceding clause, where in the threshold parameter is based on the one or more ingredients within the container.

The blender according to any preceding clause, wherein in order to adjust the one or more operational parameters of the blender the controller is further configured to pulse a power of a motor associated with the blender.

The blender according to any preceding clause, wherein the threshold parameter is based on one or more characteristics of the blender, wherein the one or more characteristics comprise at least one of: a model of the blender, a blending process, or one or more blender settings.

The blender according to any preceding clause, wherein the threshold parameter is based on one or more reference samples.

The blender according to any preceding clause, wherein in order to obtain the sensor information captured by the one or more sensors associated with the blender the controller is further configured to: receive an indication of the sensor information from a remote device.

The blender according to any preceding clause, wherein in order to determine the acoustic output does not satisfy the threshold parameter, the controller is further configured to: compare the acoustic output to the threshold parameter; and determine the acoustic output is greater than the threshold parameter.

The blender according to any preceding clause, wherein in order to determine the acoustic output does not satisfy the threshold parameter, the controller is further configured to: compare the acoustic output to the threshold parameter; and determine the acoustic output is less than the threshold parameter.

The blender according to any preceding clause, wherein in order to determine the sensor information does not satisfy the threshold parameter, the controller is further configured to: compare the sensor information to the threshold parameter; and determine the sensor information is does not equal the threshold parameter.

The blender according to any preceding clause, wherein in order to adjust the one or more operational parameters of the blender the controller is further configured to increase or decrease a power of a motor associated with the blender.

The blender according to any preceding clause, wherein in order to adjust the one or more operational parameters of the blender the controller is further configured to adjust a blending time associated with the blender.

The blender according to any preceding clause, wherein the controller is further configured to: receive an indication to initiate a quiet blending mode associated with the blender, wherein the sensor information is obtained in response to the indication to initiate the quiet blending mode.

The blender according to any preceding clause, wherein the controller is further configured to: receive an indication to initiate a learn mode associated with the blender, wherein the sensor information is obtained in response to the indication to initiate the learn mode; and map the acoustic output to a correspond power of a motor associated with the blender.

A method for operating a sound reducing system, the method comprising: obtaining sensor information captured by one or more sensors associated with a blending system; determining an acoustic output of the blending system based on the sensor information, wherein the acoustic output comprises a sound pressure output associated with the blending system; determining the acoustic output does not satisfy a threshold parameter; and adjusting one or more operational parameters of the blending system based on determining the acoustic output does not satisfy the threshold parameter.

The method according to any preceding clause, wherein the one or more sensors comprise at least one of: a microphone, an acoustic sensor, a pressure sensor, a vibration sensor, or an accelerometer.

The method according to any preceding clause, wherein the acoustic output of the blending system further comprises at least one of: an acoustic signature, a frequency of a sound output, or a vibration output associated with the blending system.

The method according to any preceding clause, further comprising: obtaining environmental information associated with one or more environmental conditions of the blending system.

The method according to any preceding clause, wherein the threshold parameter is based on the one or more environmental conditions of the blending system.

The method according to any preceding clause, further comprising: obtaining ingredient information associated with one or more ingredients within a container of the blending system.

The method according to any preceding clause, where in the threshold parameter is based on the one or more ingredients within the container.

The method according to any preceding clause, wherein adjusting the one or more operational parameters of the blending system comprises pulsing a power of a motor associated with the blending system.

The method according to any preceding clause, wherein the threshold parameter is based on one or more characteristics of the blending system, wherein the one or more characteristics comprise at least one of: a model of the blending system, a blending process, or one or more blender settings.

The method according to any preceding clause, wherein the threshold parameter is based on one or more reference samples.

The method according to any preceding clause, wherein obtaining the sensor information captured by the one or more sensors associated with the blending system comprises: receiving an indication of the sensor information from a remote device.

The method according to any preceding clause, wherein determining the acoustic output does not satisfy the threshold parameter comprises: comparing the acoustic output to the threshold parameter; and determining the acoustic output is greater than the threshold parameter.

The method according to any preceding clause, wherein determining the acoustic output does not satisfy the threshold parameter, comprises: comparing the acoustic output to the threshold parameter; and determining the acoustic output is less than the threshold parameter.

The method according to any preceding clause, wherein determining the sensor information does not satisfy the threshold parameter, comprises: comparing the sensor information to the threshold parameter; and determining the sensor information is does not equal the threshold parameter.

The method according to any preceding clause, wherein adjusting the one or more operational parameters of the blending system comprises increasing or decreasing a power of a motor associated with the blending system.

The method according to any preceding clause, wherein adjusting the one or more operational parameters of the blending system comprises adjusting a blending time associated with the blending system.

The method according to any preceding clause, further comprising: receiving an indication to initiate a quiet blending mode associated with the blending system, wherein the sensor information is obtained in response to the indication to initiate the quiet blending mode.

The method according to any preceding clause, further comprising: receiving an indication to initiate a learn mode associated with the blending system, wherein the sensor information is obtained in response to the indication to initiate the learn mode; and mapping the acoustic output to a corresponding power of a motor associated with the blending system.

A system, comprising: a processor, and a non-transitory, processor readable storage medium communicatively coupled to the processor, the non-transitory, processor readable storage medium comprising programming instructions thereon that, when executed, cause the processor to carry out the method according to claim 20.

What is claimed is:

1. A system for operating a sound reducing system, the system comprising:
a blender comprising a motor;
a capture component comprising one or more sensors configured to capture sensor information associated with the blender; and
a controller communicatively coupled to the motor and the capture component, the controller configured to:
obtain the sensor information captured by the one or more sensors;
determine an acoustic output of the blender based on the sensor information, wherein the acoustic output comprises a sound pressure output associated with the blender;
determine the acoustic output does not satisfy a threshold parameter; and
adjust one or more operational parameters of the blender based on determining that the acoustic output does not satisfy the threshold parameter.

2. The system according to claim 1, wherein the one or more sensors comprise at least one of: a microphone, an acoustic sensor, a pressure sensor, a vibration sensor, or an accelerometer.

3. The system according to claim 1, wherein the acoustic output of the blender further comprises at least one of: an acoustic signature, a frequency of a sound output, or a vibration output associated with the blender.

4. The system according to claim 1, wherein:
the controller is further configured to obtain environmental information associated with one or more environmental conditions of the blender, and
the threshold parameter is based on the one or more environmental conditions of the blender.

5. The system according to claim 1, wherein:
the controller is further configured to obtain ingredient information associated with one or more ingredients within a container of the blender, and
the threshold parameter is based on the one or more ingredients within the container.

6. The system according to claim 5, wherein in order to adjust the one or more operational parameters of the blender the controller is further configured to pulse a power of a motor associated with the blender.

7. The system according to claim 1, wherein the threshold parameter is based on one or more characteristics of the blender, wherein the one or more characteristics comprise at least one of: a model of the blender, a blending process, or one or more blender settings.

8. The system according to claim 1, wherein the threshold parameter is based on one or more reference samples.

9. The system according to claim 1, wherein in order to obtain the sensor information captured by the one or more sensors associated with the blender the controller is further configured to:
receive an indication of the sensor information from a remote device.

10. The system according to claim 1, wherein in order to determine the acoustic output does not satisfy the threshold parameter, the controller is further configured to:
compare the acoustic output to the threshold parameter; and
determine the acoustic output is greater than the threshold parameter.

11. The system according to claim 1, wherein in order to determine the acoustic output does not satisfy the threshold parameter, the controller is further configured to:
compare the acoustic output to the threshold parameter; and
determine the acoustic output is less than the threshold parameter.

12. The system according to claim 1, wherein in order to determine the sensor information does not satisfy the threshold parameter, the controller is further configured to:
compare the sensor information to the threshold parameter; and
determine the sensor information is does not equal the threshold parameter.

13. The system according to claim 1, wherein in order to adjust the one or more operational parameters of the blender the controller is further configured to increase or decrease a power of a motor associated with the blender.

14. The system according to claim 1, wherein in order to adjust the one or more operational parameters of the blender the controller is further configured to adjust a blending time associated with the blender.

15. The system according to claim 1, wherein the controller is further configured to:
receive an indication to initiate a quiet blending mode associated with the blender, wherein the sensor information is obtained in response to the indication to initiate the quiet blending mode.

16. The system according to claim 1, wherein the controller is further configured to:
receive an indication to initiate a learn mode associated with the blender, wherein the sensor information is obtained in response to the indication to initiate the learn mode; and
map the acoustic output to a corresponding power of a motor associated with the blender.

17. A blender, the blender comprising:
a motor; and
a controller communicatively coupled to the motor, the controller configured to:
obtain sensor information captured by one or more sensors associated with the blender;
determine an acoustic output of the blender based on the sensor information, wherein the acoustic output comprises a sound pressure output associated with the blender;
determine the acoustic output does not satisfy a threshold parameter; and
adjust one or more operational parameters of the blender based on determine the acoustic output does not satisfy the threshold parameter.

18. The blender according to claim 17, wherein in order to adjust the one or more operational parameters of the blender the controller is further configured to increase or decrease a power of a motor associated with the blender.

19. The blender according to claim 17, wherein in order to adjust the one or more operational parameters of the blender the controller is further configured to adjust a blending time associated with the blender.

20. A method for operating a sound reducing system, the method comprising:
obtaining sensor information captured by one or more sensors associated with a blending system;
determining an acoustic output of the blending system based on the sensor information, wherein the acoustic output comprises a sound pressure output associated with the blending system;
determining the acoustic output does not satisfy a threshold parameter; and
adjusting one or more operational parameters of the blending system based on determining that the acoustic output does not satisfy the threshold parameter.
